(19) United States
(12) Patent Application Publication
(10) Pub. No.: US 2008/0288305 A1
(43) Pub. Date: Nov. 20, 2008

(54) Enterprise Decision Management System and Method

(76) Inventors: Joseph D. LaLuzerne, Minneapolis, MN (US); John Nash, Shoreview, MN (US)

Correspondence Address: FULBRIGHT & JAWORSKI L.L.P., 80 SOUTH EIGHTH STREET, SUITE 2100, MINNEAPOLIS, MN, 55402, US

(21) Appl. No.: 11/967,792

(22) Filed: Dec. 31, 2007

Related U.S. Application Data
(60) Provisional application No. 60/938,173, filed on May 15, 2007.

(51) Int. Cl. G06Q 10/00

(52) U.S. Cl. 705/7

(57) ABSTRACT

A management system and method providing a flexible, iterative approach for conducting strategic consulting and planning engagements as well as application-based and custom system development projects. The system and method are intended to provide a unifying framework to both communicate planning and delivery approaches to clients and to enable collaboration among various personnel called upon to deliver a client solution. In one embodiment, said method includes creating a decision inventory and business process flow, identifying and designing models to inform decision yield and business architecture requirements; capturing baseline decision yield information; and quantifying potential improvements to the decision yield to determine a decision yield value proposition with said quantifying being based at least in part on said captured baseline decision yield information.

### RELATED APPLICATIONS

This application claims priority under 35 U.S.C. 119(e) from provisional U.S. Patent Application No. 60/938,173, filed May 15, 2007, the entire contents of which are incorporated herein by reference.

### BACKGROUND OF THE INVENTION

Enterprise Decision Management (EDM) is the discipline of improving and automating decisions throughout an organization—based on data, analytics, organizational policies & related software, and desired outcomes. An EDM system may consist of an analytic model-based environment that provides the capability for designing, deploying, and executing predictive processing models. Decision processing components can consist of rule-based as well as analytic models, both of which are designed to determine a particular response depending on a particular transaction or other customer interaction.

### BRIEF SUMMARY OF THE INVENTION

An improved EDM methodology is disclosed herein. This method provides a flexible, iterative approach for conducting strategic consulting and planning engagements as well as application-based and custom system development projects. EDM is intended to provide a unifying framework to both communicate planning and delivery approaches to clients and to enable collaboration among various personnel called upon to deliver a client solution.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is an depictions of a multi-step EDM system of the present invention.

FIG. 2 is a depiction of one embodiment of an EDM system in accordance with FIG. 1.

FIG. 3 is a high-level flow chart of a technical capabilities which enable an EDM system of FIG. 1.

FIG. 4 is a more detailed flow chart of the flow chart of FIG. 3.

FIG. 5 is an overview of an EDM system

### DETAILED DESCRIPTION OF THE INVENTION

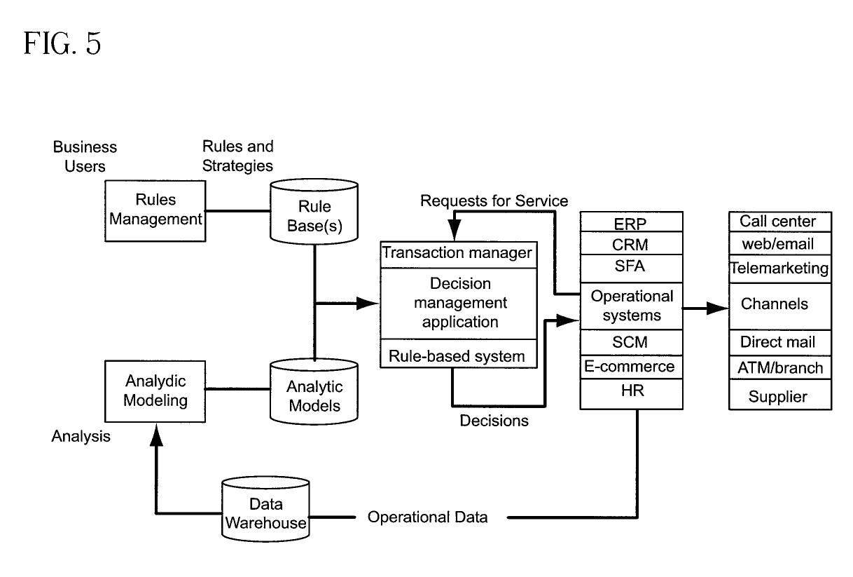

As illustrated in FIG. 5, decision processing components are called on by various operational systems to process a decision. Domain-specific expertise (in the form of rules) or analytic models are applied to arrive at a proper decision. Typically, operational systems invoke a decision processing component in the same way they invoke a call to a database. When invoked, decision processing components use the application data to make a decision based on transactional data, rules, and analytic models, as well as data maintained in data warehouses and other customer information stores. Typically the decision is passed back to the operational system that involved the call. It might also be handed off to a messaging platform for use with other operational systems. Other actions initiated by the decision might include updating a customer profile residing in a database or generating a call to some external application.

As currently practiced, EDM relies on the use of rule-based systems to provide automated decision-making capabilities. Rules are processed dynamically in response to specific events (e.g., a customer clicking on a web page advertisement or inputting facts such as automobile model and driving history into an insurance-processing application). Rule-based systems have become the technology of choice for implementing EDM applications. This is because they offer a number of advantages when used for automated decision making. First, because rules are stored separately from application and database logic, the system's decision-making logic can be changed much more easily than is possible with hard-coded applications (i.e., those employing traditional programming techniques) or applications that rely on rules maintained as database triggers. Moreover, because rules are processed dynamically by the inference engine, there is no need to recompile the application very time new rules are added or existing rules are changed. This makes rule-based systems exceedingly well suited for applications in which decision-making criteria change frequently, such as personalization systems for online sales and marketing, fraud prevention applications, financial scoring programs, and compliance systems. Rules also provide an excellent means for representing and simplifying complex business logic. Rules are expressed as “if-then” statements using English-like syntax.

Another benefit of using rule-based systems for decision management can be attributed to the expressive nature of rules, which makes it easier for less technically savvy business users, such as marketing managers and merchandisers, to update and maintain rule bases. This feature is particularly important for customer-facing applications, such as customer relationship management (CRM) or e-commerce personalization, because marketers are usually required to make frequent changes to customer scoring and other customer relationship measurement and response criteria used by such systems (e.g., changing the age of targets for promotion).

Because rules are maintained separately from application logic, companies can create a centralized rule-based repository that can help standardize and coordinate strategies across the organization, thereby dramatically changing the way an organization interfaces with its customers, partners, and employees. For example, a centralized rule base of CRM rules allows marketers to organize and coordinate CRM strategies across multiple channels. Likewise, a centralized rule base of compliance rules can help standardize and coordinate company-wide strategies for meeting organizational and governmental regulations and laws.

Rule-based systems also provide a straightforward explanation for their output. This feature is especially important for financial, insurance, and compliance applications in which regulatory requirements call for a clear explanation for refusing to approve a transaction (for instance, a loan approval) or where the ability to show that specific steps have been taken to meet regulatory criteria is necessary.

Rule-based systems require that someone creates the rules that will be applied during a response to specific events. Initial rule-base development is usually carried out by a developer experienced in implementing rule-based system who also possesses an in-depth knowledge of the application domain(s) in which the system will be deployed. This is followed by rules evaluation and testing, which is conducted by IT personnel. However, once the initial rule base has been developed and validated, it can then be maintained and updated by less technically skilled business users as needed. However, rule modifications still usually require that IT personnel test and validate the rule base to ensure correct decision processing.

It is also possible to automate some of the effort involved in initial rule-base development through the use of data mining tools that can convert decision trees and other models generated from data mining analyses into rules to be incorporated in to the EDM application's rule base. However, someone still needs to determine which rules are appropriate to apply and also test to make sure they function properly. Again, this someone must have a detailed knowledge of the domain in which the application will be used and must also be skilled in rule-based systems development.

Because of the difficulty associated with initial rule-base development, it is recommended that companies seeking to create rule-based decision-making applications go with a vendor that can offer prebuilt rule bases designed for specific domains. However, even these prebuilt rule bases require customization to support an organization's own particular CRM and other business practices needs. Hence, organizations should still plan to rely on consulting from the vendor or another firm knowledgeable in developing such applications.

As currently practiced, EDM relies primarily on the use of rule-based systems to automate decision processing; however, organizations are increasingly seeking to apply analytic modeling techniques to supplement the rule-based functionality. Analytic modeling can help facilitate EDM in several ways, including automating identification of decision-making rules for use with rule-based systems and enhancing decision processing with additional online or embedded analytic functionality.

Currently, the most common use of analytic modeling for EDM is in automating the process of creating rules for use with an EDM application's rule-based system. For example, in a retail application, analysts might extract data from a retail customer information system and load it into a data mart. Next, they might apply data mining techniques to perform customer segmentation and other analyses to uncover customer purchasing patters or trends for a particular customer demographic. For instance, they might uncover that a number of sporting goods customers who purchase tents also have a tendency to hiking socks. Should analysts and marketers deem this trend significant, they could formulate rules for entry into the EDM application's rule base (e.g., to instruct the system to present discounts on socks to customers purchasing tents). Some rule-based system products, like Fair Isaac's Blaze Advisor, feature facilities that can convert analytical results directly into if-then rules that can be processed by the inference engine. This entire process is usually performed offline.

Analytic models can also be deployed online or embedded within an EDM environment to support and enhance decision processing. Such models are frequently used for customer segmentation, behavior monitoring, or scoring purposes. These models typically take the form of decision trees or scoring models, which are accessed by the rule-based system when processing a customer transaction. Models can also be embedded (as code) within the rules to directly support analytic processing by the rules engine. For example, an EDM application might first apply an analytic model to a transaction in order to segment a customer by a particular demographic before the rules engine processes a decision. Alternatively the EDM application might apply an analytic model to a transaction in order to compute a customer score, which is then utilized by the rules engine to approve the transaction or recommends the appropriate product or service. In addition, analytic models can be used to predict the outcome of an individual prospect (or entity) on a case-by-case basis at the point of a customer-interaction decision (e.g., to determine the probability of a particular prospect having an accident).

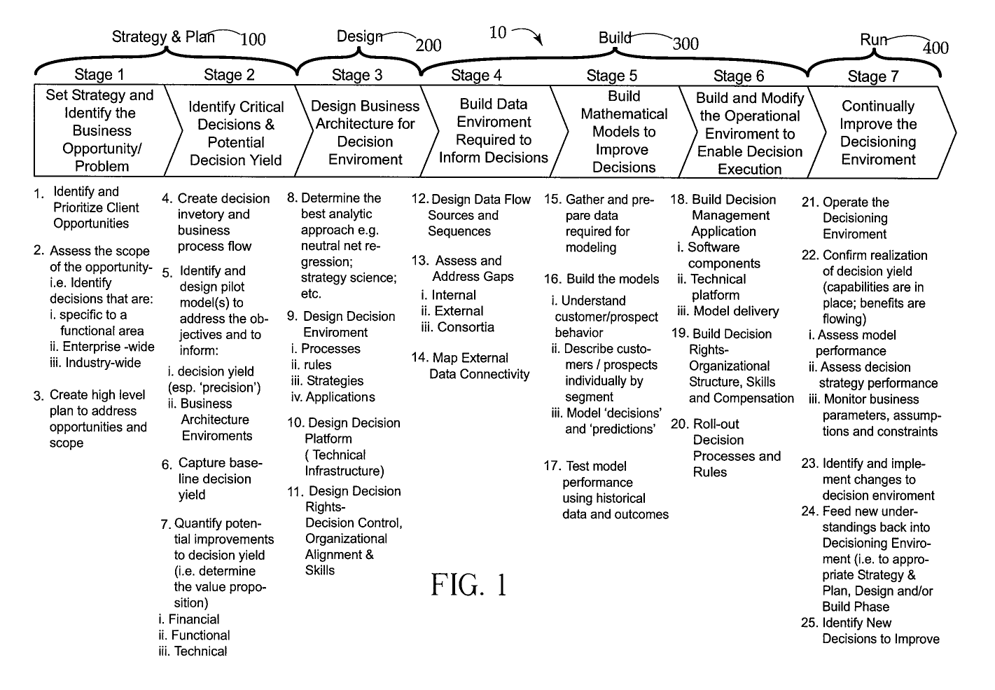

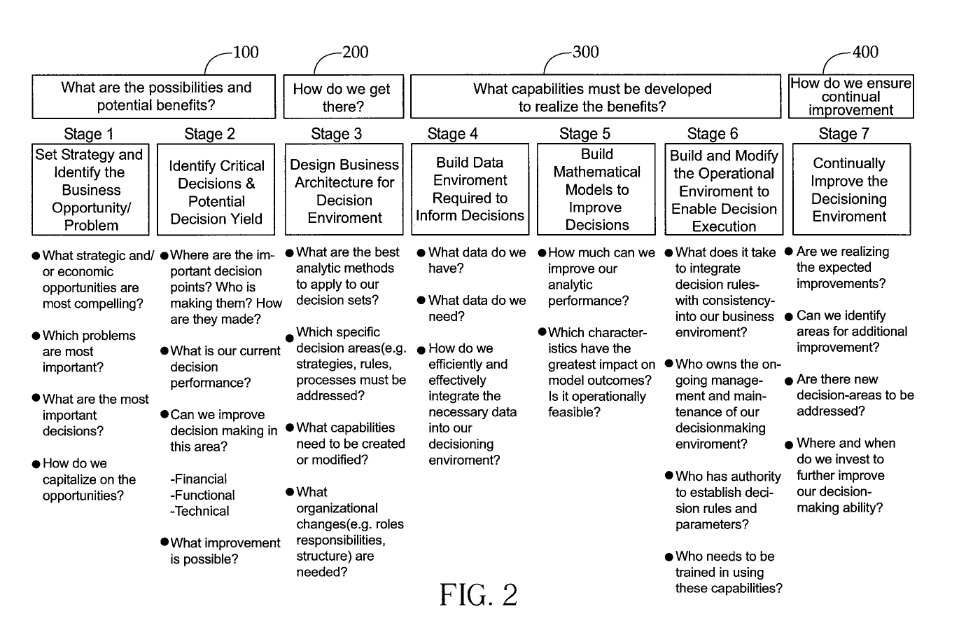

Referring to FIGS. 1 and 2, a preferred EDM system 10 and methodology includes multiple steps and covers phases required to develop an EDM environment. The phases may include: Strategy & Plan 100, Design 200, Build 300, and Run 400. Across these phases run seven Stages comprising a total of 25 high-level Steps that range from front-end “value discovery” efforts through to the running, monitoring and enhancing of a client decisioning environment.

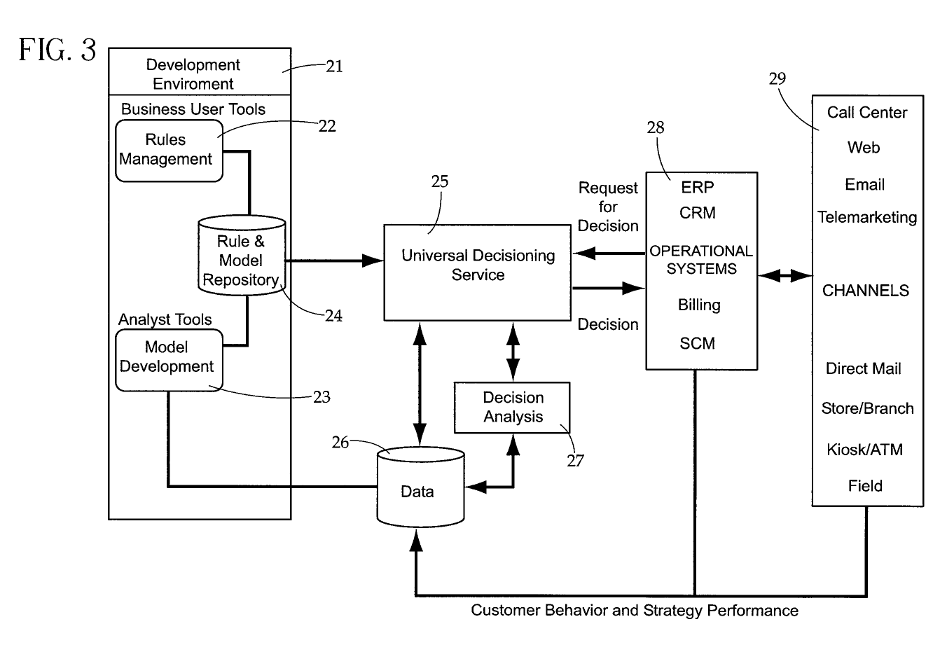

FIG. 3 is a high-level depiction of the technical capabilities needed to enable an embodiment of the EDM system 10. Development environment module 21 includes business user tools, such as Rules Management 22 and analyst tools, such as Model Development 23. Rules and models are provided in a repository 24. Universal Decision Service module 25 is in communication with development environment 21, data store 26, decision analysis module 27, and systems module 28. Requests for decisions may be made by module 26 to service 25. Decisions are communicated to system module 27. Applications module 29 along with systems module 27 yield customer behavior data and strategy performance which is stored in data store 26.

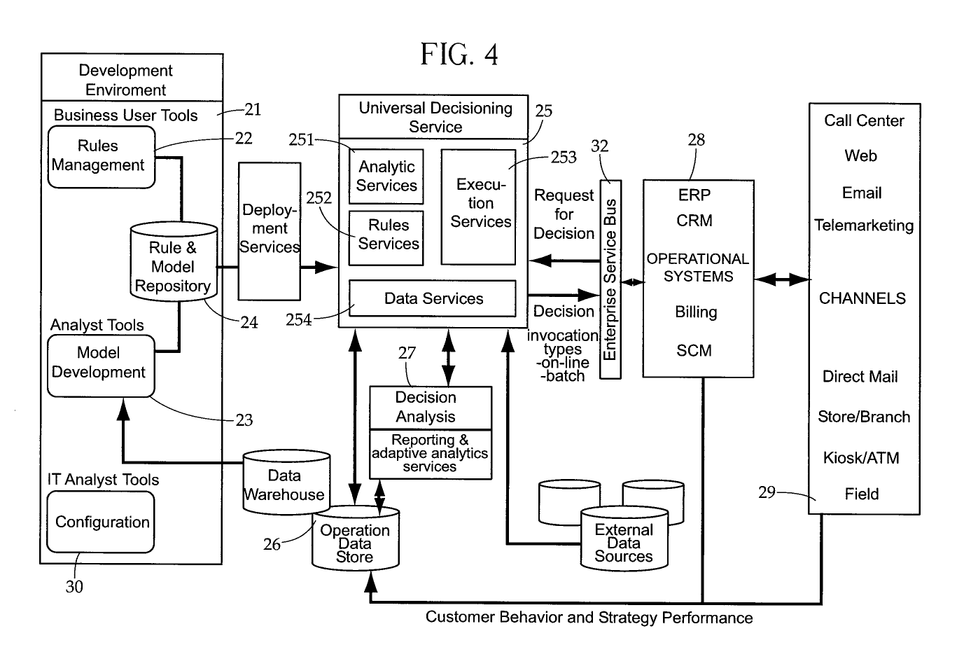

FIG. 4 is a second level depiction of the technical capabilities and service components needed to enable EDM system 10. Development environment 21 further includes IT analyst tools 30, such as Configuration. Deployment services module 31 enables and/or facilitates communication between development environment 21 and universal decisioning service module 25. Universal decisioning service module 25 provides analytic services 251, rules services 252, execution services 253 and data services 254. Enterprise service bus 32 enables and/or facilitates communication between universal decisioning service module 25 and systems module 28.

Strategy & Plan Phase 100—“Where are we Going?”

During the Strategy & Plan Phase 100, strategic client matters are discussed and explored, with broad conversations leading to the identification of specific opportunities and initiatives. The result may lead to a strategy engagement, such as to help a client become more customer-driven. (Which may lead in later phases to: determine an optimal approach to customer segmentation; define market- and customer-segment specific strategies & tactics; modify operations to align with the new customer programs; etc.) The result may also lead to a focus on specific aspects of a client decisioning environment, where tangible improvements to decision-making areas (i.e. improvements to ‘decision yield’) are identified. This may lead in later phases to: design an integrated business architecture for managing decisions; build client decision capabilities in terms of technology, business process, and organizational alignment; improve decision-precision through analytic improvements; run a client's decision environment; etc.

One main objective of phase 100 is to determine the right direction to take. Phase 100 is about identifying possibilities, and selecting the ones believed to have the greatest potential benefit to the client. Phase 100 yields a high-level plan that articulates specific opportunity areas to pursue. To ensure the viability of these opportunities, “pilot” modeling may be conducted (e.g. “Can mathematics be applied to a specific problem, and what type of performance lift can be expected?”) This is especially pertinent when it is believed that improved analytic capabilities are part of the solution. If necessary, modeling experts may be involved in phase 100 to assist in such an assessment. Finally, each opportunity area is quantified in terms of potential benefit to the client organization (financial productivity—increased revenue, decreased cost; functional productivity—organizational consistency and agility; technical productivity—increased precision and speed).

Design Phase 200—“What Will it Look Like when we Get there?”

During Design Phase 200, the analysis shifts from inquring “Where are we going?” to “What will it look like when we get there?” Specifically, analysis is performed on the opportunity area(s) identified during Strategy & Plan Phase 100. Relevant client capabilities can also be assessed (technology, business process, and organizational). A roadmap can then be created to capitalize on the new opportunities.

A client's future Decision Environment can be defined in terms of business processes and rules; the software application environment (including custom solutions); the technical infrastructure; and the organizational environment (including ‘decision rights,’ organizational alignment, and requisite skills). This definition—referred to as a ‘Business Architecture’—can become a blueprint for what is developed during Build Phase 300.

Each component of the Business Architecture must be considered in terms of both scope and context. The scope must specifically articulate the detailed requirements of each aspect of the Business Architecture. The context must define how the new Decision Environment will impact and integrate into the broader business environment. This is expressed from a business process perspective (i.e. “how will the new/modified processes dovetail with interdependent processes?”), a technical perspective (i.e. “what technical interfaces (APIs) or services (SOA) must be created?”), and an organizational perspective (i.e. “how do we ensure necessary organizational alignment across the enterprise?”).

Scope and context definitions result in a list of the detailed requirements necessary to ensure the successful development (or enhancement) of a client's Decision Environment and its integration into their overall business environment.

Build Phase 300—“What Capabilities Must be Developed?”

During Build Phase 300, all the requirements defined in Design Phase 200 are converted into business capabilities. New approaches and business processes are defined; necessary data elements are sourced and integrated; analytic models (descriptive, predictive and/or decision) are developed or enhanced; new software solutions (custom-built using tools or using customized applications) are created and tested; organizational changes are defined and endorsed, and training programs are enacted.

Detailed solution components are created, including those capabilities that enable integration within the Decision Environment and those that enable integration with the overall business environment. Program management is essential—including project tracking; communication vehicles spanning all aspects of the program; and a thorough plan for integrated testing, training, and organizational roll-out—especially for those engagements with a broad scope involving significant custom work, and impacting multiple areas of a client organization. Standard engagements with a more limited scope still require project management to ensure the smooth adoption of new capabilities delivered.

Build Phase 300 may end when new capabilities are integrated into the client business environment. Phase 300 may include monitoring the new systems and capabilities to ensure they are working properly, and to address any immediate issues that surface.

Run Phase 400—“How do we Ensure Continual Improvement?”

The successful integration of new capabilities into a client environment is just the beginning. At this point, Run Phase 400 begins, during which the Decisioning Environment is operated and monitored for effectiveness. During phase 400, results are gathered and assessed to confirm that business benefit—as defined during Strategy & Plan Phase 100—is realized. Based on the results of this analysis, potential changes to the decisioning environment—from minor adjustments to major enhancements—are identified. These new opportunities are then routed, as appropriate, to another phase. (Minor adjustments will often go straight to a subsequent Design or even Build Phase, while major enhancements are fed into a subsequent Strategy & Plan Phase.) The Run Phase 400 is ongoing, and leads to multiple iterations through the preceding phases, based on necessary enhancements and new opportunities.

As described above, a preferred EDM system and methodology includes multiple steps and covers phases required to develop an EDM environment. Referring now to FIG. 2, which depicts one embodiment of an EDM system and methodology of the present invention, across phases 100, 200, 300, 400 run seven Stages comprising a total of 25 high-level steps that range from front-end “value discovery” efforts through to the running, monitoring and enhancing of a client decisioning environment, as shown in FIG. 1.

Stages of EDM System and Method
1. Set Strategy and Identify the Business Opportunity/Problem
2. Identify Critical Decisions and Potential Decision Yield
3. Design Business Architecture for Decision Environment
4. Build Data Environment Required to Inform Decisions
5. Build Mathematical Models to Improve Decisions
6. Build and Modify the Operational Environment to Enable Decision Execution
7. Continually Improve the Decisioning Environment

Stage 1 Set Strategy & Identify the Business Opportunity/Problem.

Analysis at Stage 1 may include evaluation of strategic and/or economic opportunities, evaluation of which problems are most important, evaluation of how to capitalize on the opportunities.

At step 1, client opportunities are identified and prioritized. Next, an assessment of the scope of the opportunities is made. Decisions that are specific to a functional area, enterprise-wide, or industry-wide can be assessed. Stage 1 concludes with creation of a high-level plan to address opportunities and scope.

Implementation steps of Stage 1 may include: identification and prioritization of client opportunities, assessing the scope of the opportunity—i.e. identify decisions that are: specific to a functional area, and creating a high-level plan to address opportunities and scope.

Stage 2 Identify Critical Decisions & Potential Decision Yield

Stage 2 evaluations include: “Where are the important decision points?” Who is making them?” “How are they made?” “What is our current decision performance?” “Can we improve decision making in this area?” and “What improvement is possible?”

Implementation steps at Stage 2 include creating decision inventory and business process flow, identifying and designing “pilot” model(s) to address the objectives and to inform: Decision Yield (esp. ‘precision’), Business Architecture Requirements, Capture baseline decision yield, and quantifying potential improvements to Decision Yield (i.e. determine the value proposition).

At step 4, decision inventory and business process flow are created. At step 5, an identification and design of “pilot” model(s) to address the objectives is made. Information relating to Decision Yield, especially precision, and Business Architecture requirements is defined. Baseline decision yields are captured at step 6. Finally, potential improvements to decision yield are quantified at step 7. The value propositions may include financial, functional and technical improvements.

Stage 3 Design Business Architecture for Decision Environment

Stage 3 evaluation include: “What are the best analytic methods to apply to our decision sets?” “Which specific decision areas (e.g. strategies, rules, processes) must be addressed?” “What capabilities need to be created or modified?” and “What organizational changes (e.g. roles, responsibilities, structure) are required?”

Stage 3 commences with a determination of the “best” analytic approach for application to the decision platform at step 8. The “best” analytic approach will be dependent on the opportunity, industry, etc. Possible analytic approaches include, but are not limited to, neural net, regression and strategy science. The decision environment is next defined at step 9 with consideration to processes, rules, strategies and applications. The decision platform, or technical infrastructure, is designed at step 10. Stage 3 concludes with design of decision rights, e.g., decision control, organizational alignment and skills.

Stage 4 Build Data Environment Required to Inform Decisions

Stage 4 evaluations include: “What data do we have?” “What data do we need?” “How do we efficiently and effectively integrate the necessary data into our decisioning environment?”

Stage 4 commences with design of data flow at step 12. Sources and sequences may be defined. Decision gaps are assessed and addressed at step 13. Gaps may be internal, external or consortia related. Stage 4 may conclude with mapping of External Data Connectivity at step 14.

Stage 5 Build Mathematical Models to Improve Decisions

Stage 5 evaluations include “How much can we improve our analytic performance?” “Which characteristics have the greatest impact on model outcomes?” and “Is it operationally feasible?”

Stage 5 commences at step 15 with gathering and preparing data required for modeling. Models are built at step 16 and tested at step 17. Model performance may be tested using historical data and outcomes.

Stage 5 implementation steps include gathering and preparing data required for modeling, building the models, understanding customer/prospect behavior, describing customers/prospects—individually/by segment, modeling ‘decisions’ and ‘predictions’, and testing model performance—leveraging historical data and outcomes

Stage 6 Build and Modify the Operational Environment to Enable Decision Execution

Stage 6 evaluations include “What does it take to integrate decision rules—with consistency—into our business environment?” “Who owns the on-going management and maintenance of our decision-making environment?” “Who has authority to establish decision rules and parameters?” “Who needs to be trained in using these capabilities?”

Stage 6 commences with building decision management applications at step 18. Software components, technical platform and model delivery constraints can be defined. Decision rights are defined at step 19. Decision rights can be defined in view of, for example, organizational structure, skills and compensation. Decision processes and rules may be rolled-out at step 20.

Stage 7 Continually Improve the Decisioning Environment

Stage 7 evaluations include: “Are we realizing the expected improvements?” “Can we identify areas for additional improvement?” Are there new decision-areas to be addressed?” “Where and when do we invest to further improve our decision-making ability?”

Stage 7 commences with operating the Decisioning Environment at step 21. Realization of Decision Yield is confirmed at step 22. Changes to Decision Environment can be identified and implemented at step 23. New understandings may be fed back into Decision Environment at step 24. New decisions may be identified at step 25.

Implementation steps of Stage 7 include: operating the Decision Environment, confirming realization of decision yield (capabilities are in place; benefits are flowing), assessing model performance, assessing decision-strategy performance, monitoring business parameters, assumptions, and constraints, identifying and implementing changes to Decision Environment, providing feedback of new understandings to Decisioning Environment (i.e. to appropriate Strategy & Plan, Design, and/or Build Phase), and identifying new decisions to improve.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for enterprise decision management comprising:
a strategy and plan stage module for identifying and prioritizing client opportunities, capturing baseline decision yield information, and quantifying potential improvements to decision yield;
a design stage module for determining an analytical approach and designing a decisioning environment; and
a run stage module for operating the decisioning environment, said decisioning environment defined at least in part by data environments, decision rights, and decision processes and rules.

2. The system of claim 1 wherein the strategy and plan stage module additionally assesses the scope of client opportunities and creating a high-level plan to address client opportunities and scope.

3. The system of claim 1 wherein the design stage module determines the best analytic approach for the decisioning environment.

4. The system of claim 3 wherein the design stage module defines decision rights, including decision control.

5. The system of claim 1 further comprising:
a build stage module for defining data environments, decision rights, and decision processes and rules, and wherein said build stage module assesses and addresses decision gaps.

6. The system of claim 5 wherein the build stage module maps external data connectivity.

7. The system of claim 6 wherein the build stage module tests model performance using historical data and outcomes.

8. The system of claim 5 wherein the build stage module defines a decision management application.

9. The system of claim 1 wherein the build stage module utilizes mathematical modeling to improve the decisioning environment.

10. The system of claim 1 wherein the run stage module confirms realization of decision yield.

11. The system of claim 1 wherein the run stage module implements changes to the decisioning environment.

12. The system of claim 1 wherein the run stage module feeds new understandings back to the decisioning environment.

13. The system of claim 1 wherein the run stage module identifies new decisions to improve.

14. A method for developing an enterprise decision management system (EDM) comprising:
identifying a client opportunity;
capturing baseline decision yield information;
quantifying potential improvements to decision yield;
determining an analytical approach and designing a decisioning environment;
defining decision rights and processes; and
operating the decisioning environment based on said defined decision rights and processes.

15. The method of claim 14 further comprising:
assessing a scope of the client opportunity.

16. The method of claim 15 further comprising:
creating a decision inventory and business process flow based on said scope.

17. The method of claim 16 further comprising:
identifying and designing pilot modules to inform decision yield analysis based on said decision inventory and business process flow.

18. The method of claim 17 wherein said pilot modules are utilized to evaluate business architecture requirements.

19. The method of claim 14 further comprising:
quantifying potential improvements to the decision yield.

20. The method of claim 19 wherein said quantifying and determining includes evaluation of multiple different analytic approaches and selection of one of the multiple different approaches in view of the business opportunity, business architecture or decision yield analyses.

21. The method of claim 14 wherein said defining includes designing decision rights in view of decision control information and organization alignment or skills information.

22. The method of claim 21 wherein said designing decision rights includes determining organizational structure, skills and compensation.

23. The method of claim 14 further comprising:
confirming realization of decision yield in the operating environment.

24. The method of claim 14 further comprising:
identifying and implementing changes to the decisioning environment.

25. The method of claim 14 further comprising:
feeding back revelations yielded from the operating decisioning environment and changing the decisioning environment based on said revelations.

26. A method for implementing an enterprise decision management system comprising:
defining a decision yield;
quantifying potential improvements to the decision yield; and
determining the best analytic approach for designing and implementing a decisioning environment based on at least said decision yield and said potential improvements to said decision yield.

27. The method of claim 26 wherein said best analytic approach is selected from among the group of: neural net, regression and strategy science.

28. An enterprise decision management system (EDM) method comprising:
creating a decision inventory and business process flow;
identifying and designing models to inform decision yield and business architecture requirements;
capturing baseline decision yield information; and
quantifying potential improvements to the decision yield to determine a decision yield value proposition, said quantifying being based at least in part on said captured baseline decision yield information.
